(19) United States
(12) Patent Application Publication
(10) Pub. No.: US 2008/0296096 A1
(43) Pub. Date: Dec. 4, 2008

(54) Mechanical adjustment device of a pressing and guiding sheave assembly of an aerial rope of a mechanical lift installation

(75) Inventors: Romain Bertrand, Voreppe (FR); Jean Souchal, Grenoble (FR)

Correspondence Address: OLIFF & BERRIDGE, PLC, P.O. BOX 320850, ALEXANDRIA, VA, 22320-4850, US

(73) Assignee: POMAGALSKI SA., FONTAINE (FR)

(21) Appl. No.: 12/153,232

(22) Filed: May 15, 2008

(30) Foreign Application Priority Data
Jun. 4, 2007 (FR) 07 03952

(51) Int. Cl. B66B 11/08

(52) U.S. Cl. 187/266

(57) ABSTRACT

A mechanical adjustment device of a pressing and guiding sheave assembly of an aerial rope of a mechanical lift installation comprises a separating element moving rope away, fixed to the support frame of the sheave assembly by connecting means ensuring independently from one another a first free movement of the separating element in a lateral direction of the sheave assembly and a second controlled movement at least in a transverse direction of the sheave assembly between a working position wherein the separating element presses against the rope to automatically release the main sheaves of the sheave assembly and a standby position disengaged from and away from the rope.

### BACKGROUND OF THE INVENTION

The invention relates to a mechanical adjustment device of a pressing and guiding sheave assembly of an aerial rope of a mechanical lift installation, said sheave assembly being equipped with main roller sheaves for guiding the rope, mounted rotating on a support frame along parallel axes of rotation staggered along the support frame in a longitudinal direction of the sheave assembly substantially parallel to the direction of the rope.

### STATE OF THE ART

In mechanical lift installations of the chair-lift or gondola car type, the aerial rope is guided and secured on each pylon by a bottom sheave assembly with roller sheaves for supporting and guiding of the rope when the latter runs on the line and/or by a top sheave assembly with compression and guiding roller sheaves. A mixed sheave assembly comprises both a bottom sheave assembly and a top sheave assembly. These different combinations of sheave assemblies constitute different variants of rope pressing and guiding sheave assemblies. The invention relates to adjustment of such sheave assemblies, whatever the variant.

The pylons are located between the loading and unloading terminals of the installation. Chairs and/or cars are fixed to the rope by means of fixed or detachable grips. The roller sheaves of the sheave assembly are generally associated in pairs and are fitted on the ends of primary girders articulated in their middle part on the ends of secondary girders, themselves fitted in the same way on tertiary girders, and so on depending on the number of main sheaves. The last girder is mounted articulated in its middle part on a beam of the bearing structure of the pylon. These elementary (primary, secondary, tertiary etc . . . ) girders together form a support frame of the main sheave assembly. In this way, the main sheaves of the sheave assembly are mounted rotating on the support frame along parallel axes of rotation staggered along the support frame in a longitudinal direction of the sheave assembly which is substantially parallel to the direction of the rope. Such a standardized arrangement enables the sheaves to follow the path of the rope with a homogeneous distribution of the load on the sheaves, regardless of the load conditions.

For a pressing and guiding sheave assembly, whatever the variant of the embodiment, the positioning of each of the main sheaves in a lateral direction of the sheave assembly (i.e. a direction parallel to the axes of rotation of the sheaves) is a determining factor in terms of maintenance and safety of the sheave assembly and more generally of the installation as a whole. A sheave assembly in which at least one of the sheaves presents a lateral offset with respect to the natural configuration of the rope (spatial configuration of the rope corresponding to alignment of the sheave assemblies of the two directly adjacent upline and downline pylons) does in fact cause torsion of the rope. This results in premature wear of the rope, of all the sheaves of the sheave assembly, in particular at the level of the tires, and of the detachable vehicle grips when the latter are detached due to the torsion torque being released. Torsion of the rope also has the consequence of making the vehicles suspended on the line and near the wheels lose their horizontality.

Known methods for adjusting sheave assemblies implement complex and onerous equipment and are difficult to apply. Furthermore, the quality of adjustment obtained often remains mediocre on account of the adjustment time required. This is why sheave assembly adjustment operations are very often neglected and the operating personnel prefer performing excessive maintenance of the installation equipment (sheaves, rope, grips . . . ). These maintenance operations always involve installation downtime resulting in considerable inconvenience for the users and financial shortfalls for the installation operators.

### OBJECT OF THE INVENTION

The object of the invention consists in providing a mechanical adjustment device enabling adjustment operations of a pressing and guiding sheave assembly of an aerial rope of a mechanical lift installation to be simplified, while at the same time improving the adjustment quality.

The device according to the invention is remarkable in that it comprises a separating element moving rope away, fixed to the support frame of the sheave assembly by connecting means ensuring independently from one another:
a first free movement of the separating element in a lateral direction of the sheave assembly that is parallel to the axes of rotation of the main sheaves,
and a second controlled movement, at least in a transverse direction of the sheave assembly perpendicular to the longitudinal and lateral directions, between a working position wherein the separating element presses against the rope to automatically release the main sheaves of the sheave assembly, and a standby position disengaged from and away from the rope.

When the separating element is in standby position, the rope is pressing on the main roller sheaves of the sheave assembly to be guided thereby. Free movement of the separating element in the lateral direction of the sheave assembly enables the separating element to be positioned laterally vertical to the rope that is still engaged in the main sheaves. Controlled movement of the separating element to the working position causes automatic release of the sheaves and elimination of any torsion torque that may have been applied to the rope before being moved away. This transverse movement of the separating element to the working position can therefore be accompanied by a lateral movement mainly resulting from the rope returning automatically to its natural configuration after a torsion torque has been released when such a torque was fortuitously applied to the rope before disengagement. This lateral movement is made possible by the fact that the connecting means enable the separating element to move freely in the lateral direction. When the rope is not subject to any torsion torque, the lateral positioning of the main sheaves then simply has to be adjusted so that each one is positioned vertical to the rope which is pressing on the separating element still in the working position. When this lateral adjustment has been completed, the main sheaves of the sheave assembly present a longitudinal alignment coinciding with the direction followed by the rope when the latter is in its natural configuration. Controlled movement of the separating element to the standby position causes the rope to move towards and engage in the sheaves, the lateral positioning whereof after adjustment ensures that no torsion torque is generated on the rope when engaging in the sheaves.

According to a preferred embodiment, the connecting means comprise a blocking mechanism for blocking the separating element in the working position, for example a mechanism with automatic locking and manual unlocking.

### BRIEF DESCRIPTION OF THE DRAWINGS

Other advantages and features will become more clearly apparent from the following description of a particular embodiment of the invention given for non-restrictive example purposes only and represented in the accompanying drawings, in which:

FIGS. 1 to 3 represent, in front view, a part of a pressing and guiding sheave assembly equipped with an example of an adjusting device according to the invention, in which the separating element is respectively in standby position, in an intermediate position between standby position and working position, and in working position,

FIG. 4 is a side view of the sheave assembly of FIG. 3.

### DESCRIPTION OF A PREFERRED EMBODIMENT OF THE INVENTION

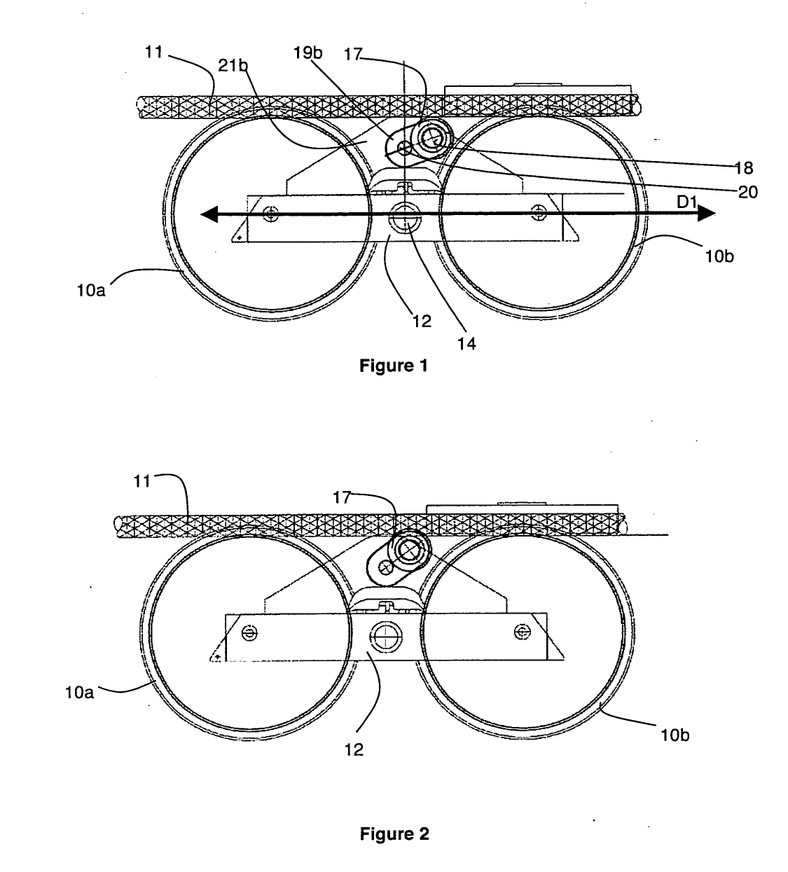

FIGS. 1 to 4 illustrate two main roller sheaves 10a, 10b of a pressing and guiding sheave assembly of an aerial rope 11 of a mechanical lift installation. Roller sheaves 10a, 10b of the sheave assembly are mounted on the ends of a primary girder 12. Primary girder 12 is articulated in the middle part thereof on the ends of a secondary girder 13. Primary girder 12 is mounted pivoting freely around a cylindrical pivoting axis 14 secured to secondary girder 13 by any suitable fixing means such as a nut and bolt system 15. Secondary girder 13 is itself mounted in the same way on a tertiary girder (not represented), and so on depending on the number of main sheaves. The last girder is mounted articulated in the middle part thereof on a beam of a support structure (not represented) of the pylon.

The set of elementary girders of the sheave assembly (primary 12, secondary 13, tertiary etc . . . ) forms the support frame of the sheave assembly. The two primary 12 and secondary 13 girders represented therefore only constitute a part of the support frame. Therefore, in the same way as for sheaves 10a,10b, all the main sheaves (variable in number depending on the number of elementary girders) of the sheave assembly are mounted rotating on the support frame with parallel axes of rotation staggered along the support frame in a longitudinal direction D1 (see arrow in FIG. 1) of the sheave assembly which is parallel to the direction of rope 11. The longitudinal direction D1 may be inclined, in the same way as rope 11, depending on the applications.

The pressing and guiding sheave assembly partially represented in FIGS. 1 to 4 is a bottom sheave assembly: the two main sheaves 10a,10b represented are therefore roller sheaves for supporting and guiding of the rope 11. Indifferently, the description that follows could be adapted to a top pressing and guiding sheave assembly equipped with roller sheaves for compressing and guiding of the rope.

The pressing and guiding sheave assembly, only a part whereof is represented in FIGS. 1 to 4, is equipped with an example of adjustment device 16 according to the invention. Such an adjustment device 16 can either be integrated in the sheave assembly construction or be added thereto in the form of any suitable removable fixing means.

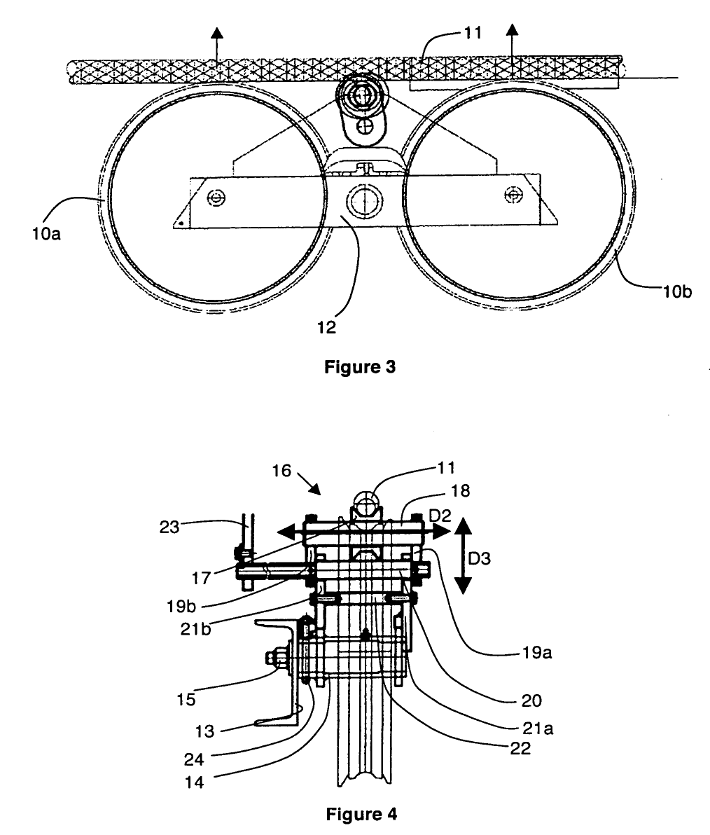

In FIGS. 1 to 4, adjustment device 16 is added above primary girder 12 by fixing means that will be described further on. Adjustment device 16 notably comprises an auxiliary roller sheave 17 mounted with a sliding pivot connection on a cylindrical rotation shaft 18. The axis of revolution of rotation shaft 18, which is parallel to the axes of rotation of main sheaves 10a, 10b, corresponds to a lateral direction D2 of the sheave assembly (see arrow in FIG. 4). The lateral direction D2 of the sheave assembly is therefore parallel to the axes of rotation of the set of main sheaves of the sheave assembly, in particular parallel to the axes of rotation of main sheaves 10a, 10b. The lateral direction D2 is therefore horizontal. The direction perpendicular to the longitudinal direction D1 and to the lateral direction D2 corresponds to the transverse direction D3 of the sheave assembly (see arrow in FIG. 4). The transverse direction D3 can therefore be vertical or inclined with respect to the vertical with an angle equal to the angle of incline of the longitudinal direction D1 with respect to the horizontal, if this is the case. The sliding pivot connection between auxiliary sheave 17 and rotation shaft 18 allows both free rotation of auxiliary sheave 17 around an axis of rotation coinciding with the lateral direction D2, and free translation of auxiliary sheave 17 in the lateral direction D2. For fitting purposes, auxiliary sheave 17 comprises a central bore of slightly larger diameter than the diameter of rotation shaft 18 so as to determine a functional assembly clearance. Lubricating means, for example of oil or grease type, can be provided between the bore of auxiliary sheave 17 and rotation shaft 18. Another solution consists in fitting a self-lubricating journal bearing in the bore of auxiliary sheave 17.

Rotation shaft 18 is joined to the sheave assembly support frame (here to primary girder 12) by raising means comprising for example two flanges 19a, 19b opposite one another in the lateral direction D2. Flanges 19a, 19b are mounted pivoting on primary girder 12 along the same pivoting axis parallel to the axes of rotation of main sheaves 10a, 10b. The pivoting axis of flanges 19a, 19b is therefore parallel to the lateral direction D2.

Such a pivoting movement of flanges 19a, 19b can for example be obtained by means of an assembly comprising a pivoting shaft 20 parallel to D2 connecting the two flanges 19a, 19b and securedly attached thereto, pivoting shaft 20 being articulated on primary girder 12. Articulation of pivoting shaft 20 on the support frame can be achieved by any means, for example by means of two support plates 21a, 21b securedly attached to primary girder 12 and arranged opposite one another in the lateral direction D2. Each support plate 21a, 21b comprises a though-hole in the upper part thereof for fitting an end of pivoting shaft 20 with rotation. The two support plates 21a, 21b are joined to one another by a strengthening spacer 22.

Each flange 19a, 19b is fixed to one end of rotation shaft 18 of auxiliary sheave 17 in a zone of said flange 19a, 19b offset in the longitudinal direction D1 and/or transverse direction D3 with respect to the assembly zone to the support frame. For each flange 19a, 19b, the assembly zone to the support frame corresponds to the junction zone with pivoting shaft 20. In other words, pivoting shaft 20 and rotation shaft 18 are parallel and offset in any plane including the longitudinal direction D1 and transverse direction D3. In this way, the pivoting movement of flanges 19a, 19b causes a rotational movement of rotation shaft 18 (and therefore of auxiliary sheave 17) centered around the pivoting axis of flanges 19a, 19b and with an angle equal to the pivoting angle of flanges 19a, 19b. This movement of auxiliary sheave 17 therefore takes place in the transverse direction D3 and/or in the longitudinal direction D1. Such a movement of auxiliary sheave 17 enables the latter to be moved between a working position (FIGS. 3 and 4) and a standby position (FIG. 1) passing via an intermediate position (FIG. 2).

The raising means further comprise means for moving flanges 19a, 19b. These means for moving can be of any suitable type (mechanical, electrical, hydraulic, pneumatic, manual, etc.). In this example, the means for moving are formed by an actuating lever 23 fixed at one of the ends thereof to one of the ends of pivoting shaft 20. Actuating lever 23 and pivoting shaft 20 are perpendicular to one another. Control of actuating lever 23 is manual. A gearing-down device can be fitted between actuating lever 23 and pivoting shaft 20.

The raising means of rotation shaft 18 are therefore achieved, in this example, by flanges 19a, 19b and by the assembly ensuring pivoting of flanges 19a, 19b (pivoting shaft 20 mounted pivoting on the support frame and means for moving flanges 19a, 19b).

When auxiliary sheave 17 is in standby position (FIG. 1), rope 11 is pressing on main roller sheaves 10a,10b of the sheave assembly to perform guiding thereof when the rope is running on the line. The pressing and guiding sheave assembly being of the bottom type in this example, pressing of rope 11 on sheaves 10a, 10b consists in support of rope 11 by sheaves 10a, 10b. Free movement of auxiliary sheave 17 in the lateral direction D2 of the sheave assembly enables the operator to position auxiliary sheave 17 laterally approximately vertically to rope 11 (underneath rope 11 in this example) when the latter is still engaged in main sheaves 10a, 10b. Movement (FIG. 2) of auxiliary sheave 17 to the working position (FIGS. 3 and 4), commanded by the operator by manual action on actuating lever 23, makes rope 11 move away from main sheaves 10a, 10b, which is sufficient to automatically release said sheaves 10a, 10b. Considering the type of sheave assembly in the example, moving rope 11 away from the sheaves consists in lifting rope 11 up from sheaves 10a, 10b. This disengagement of sheaves 10a, 10b means that any torsion torque applied to rope 11, before the latter is released, due to incorrect longitudinal alignment of main sheaves 10a, 10b, is eliminated.

At least transverse movement of auxiliary sheave 17 to the working position can therefore be accompanied by a lateral movement in the lateral direction D2. This lateral movement can on the one hand originate from automatic compensation of a lateral offset that may exist, before disengagement, between auxiliary sheave 17 and the vertical plane passing via rope 11 still engaged in main sheaves 10a, 10b. Such a lateral offset can in particular be due to bad positioning of auxiliary sheave 17 by the operator. This lateral movement of auxiliary sheave 17 can moreover, and in fact mainly, result from automatic return of rope 11 to its natural configuration after a torsion torque has been released when such a torque was fortuitously applied to rope 11 before release. The natural configuration of rope 11 corresponds here to the spatial configuration of rope 11 when the latter is pressing on the sheave assemblies of the two directly adjacent upline and downline pylons. The natural configuration is therefore imposed by the alignment of the sheave assemblies of the two directly adjacent upline and downline pylons. When rope 11 is disengaged from main sheaves 10a, 10b by auxiliary sheave 17 and therefore free from torsion torque, rope 11 is in its natural configuration. In this configuration of rope 11, the maintenance operator then simply has to adjust the lateral positioning of main sheaves 10a, 10b by means of the conventional sheave assembly means so that each of the main sheave assemblies 10a, 10b is positioned vertically to rope 11. When this lateral adjustment has been completed, all the main sheaves 10a, 10b of the sheave assembly present a longitudinal alignment which coincides with the direction followed by rope 11 when the latter is in its natural configuration. The maintenance operator then commands movement of auxiliary sheave 17 to standby position. This results in transverse movement of rope 11 (consisting here in downwards movement) towards sheaves 10a, 10b which is terminated by engagement of rope 11 in main sheaves 10a, 10b, the lateral positioning of the latter after adjustment ensuring that no torsion torque is generated on rope 11 when the latter engages in main sheaves 10a, 10b.

Auxiliary sheave 17 therefore constitutes a separating element moving rope 11 away. The separating element is fixed to the sheave assembly support frame by connecting means ensuring independently from one another:
a first free movement of the separating element in a lateral direction D2 of the sheave assembly that is parallel to the axes of rotation of main sheaves 10a, 10b,
and a second controlled movement, at least in a transverse direction D3 of the sheave assembly perpendicular to the longitudinal and lateral directions D1, D2, between a working position (FIGS. 3 and 4) wherein the separating element presses on rope 11 (for example via the underneath) to automatically release main sheaves 10a, 10b of the sheave assembly, and a standby position (FIG. 1) disengaged from and away from rope 11.

The second movement is commanded by means of actuating lever 23 whereas the first movement is due to the freedom of translation of the separating element (auxiliary sheave 17) in the lateral direction D2.

The connecting means between the separating element and support frame (primary girder 12) are formed by rotation shaft 18, by its raising means, and by support plates 21a, 21b. Fixing of support plates 21a, 21b to primary girder 12 may be removable. In the example illustrated, fixing of support plates 21a, 21b (which are joined to one another by strengthening spacer 22) on primary girder 12 is performed by means of a clamp 24 securedly attached to support plate 21b arranged on the same side as secondary girder 13. Clamp 24 is able to perform radial clamping of pivot 14. According to a possible embodiment, clamp 24 comprises a U-shaped clamping element the branches of which are provided with a thread at the ends thereof. Each of the threads operates in conjunction with a securing nut. Pivot 14 passes through U-shaped clamp, the branches whereof pass through support plate 21b via passage holes arranged in support plate 21b. Each securing nut is screwed onto the part of a branch of securing element that is salient from the passage holes of support plate 21b.

Furthermore, the connecting means can include a blocking mechanism (not represented) designed to block the separating element in the working position. The blocking mechanism is advantageously a mechanism with automatic locking and manual unlocking, for example by the use of a back-stop ratchet device between pivoting shaft 20 and sheave assembly support frame.

Although, in the example described above, the separating element performs lifting of rope 11 upwards in the working position to release main support and guiding sheaves 10a, 10b, adjustment device 16 can be modified and adapted to enable adjustment of a top sheave assembly provided with compression and guiding sheaves. In this case, the modifications made to adjustment device 16 will be such that the separating element will perform lowering of rope 11 in the working position to automatically release compression and guiding sheaves. Whether it be by raising or lowering, the separating action performed by the separating element in the working position is achieved by pressing on rope 11 to bring about a sufficient transverse movement of the latter to automatically release main sheaves 10a, 10b.

Finally, it can be provided for auxiliary sheave 17 to be mounted on shaft 18 with a sliding connection allowing translational movement in the lateral direction D2 only and preventing rotational movement around shaft 18. Moreover, it is clear that the separating element can take another form than a sheave without departing from the scope of the invention. For example, it can be achieved by means of a cam or a bearing pad. Finally, the connecting means can be achieved in any suitable manner provided they ensure independently from one another a first free movement of the separating element in a lateral direction D2 of the sheave assembly and a second controlled movement at least in the transverse direction D3 of the sheave assembly. The second movement may involve movement of the separating element in the transverse direction D3 only, for example by means of a slide connection oriented in the transverse direction D3.

1. A mechanical adjustment device of a pressing and guiding sheave 5 assembly of an aerial rope of a mechanical lift installation, said sheave assembly being equipped with main roller sheaves for guiding the rope, mounted rotating on a support frame along parallel axes of rotation staggered along the support frame in a longitudinal direction of the sheave assembly substantially parallel to the direction of the rope, comprising a separating element moving rope away, fixed to the support frame of the sheave assembly by connecting means ensuring independently from one another:
a first free movement of the separating element in a lateral direction of the sheave assembly that is parallel to the axes of rotation of the main sheaves,
and a second controlled movement, at least in a transverse direction of the sheave assembly perpendicular to the longitudinal and lateral directions, between a working position wherein the separating element presses against the rope to automatically release the main sheaves of the sheave assembly, and a standby position disengaged from and away from the rope.

2. The device according to claim 1, wherein the connecting means comprise a blocking mechanism for blocking the separating element in the working position.

3. The device according to claim 2, wherein the blocking mechanism is a mechanism with automatic locking and manual unlocking.

4. The device according to claim 1, wherein the separating element consists of an auxiliary roller sheave mounted with a sliding pivot connection on a rotation shaft that is parallel to the axes of rotation of the main sheaves of the sheave assembly and that is connected to the support frame of the sheave assembly by raising means.

5. The device according to claim 4, wherein the raising means comprise two flanges opposite one another in the lateral direction and mounted pivoting on the support frame along the same pivoting axis parallel to the axes of rotation of the main sheaves, each flange being fixed to one end of the rotation shaft of the auxiliary sheave in a zone of said flange offset in the longitudinal direction and/or transverse direction with respect to the zone of assembly to the support frame.
